(19) United States
(12) Patent Application Publication
(10) Pub. No.: US 2018/0073881 A1
(43) Pub. Date: Mar. 15, 2018

(54) Computer-Implemented Method, System, and Computer Program Product for Detecting Modes of Transportation of a User

(71) Applicant: Bayerische Motoren Werke Aktiengesellschaft, Muenchen (DE)

(72) Inventors: Michael KARG, Eching (DE); Roman ROOR, Munich (DE); Markus STRASSBERGER, Wartenberg (DE); Aaron FRUEH, Unterfoehring (DE); Olga KARSUNKE, Munich (DE)

(21) Appl. No.: 15/816,303

(22) Filed: Nov. 17, 2017

Related U.S. Application Data
(63) Continuation of application No. PCT/EP2015/066506, filed on Jul. 20, 2015.

(30) Foreign Application Priority Data
May 18, 2015 (DE) 10 2015 209 056.6

(51) Int. Cl. G01C 21/34; G01C 21/16

(52) U.S. Cl. CPC G01C 21/3423; G06F 17/30241; G01C 21/16

(57) ABSTRACT

A computer-implemented method for detecting modes of transportation of a user includes detecting one or more key points in a digital map, determining a key point of the one or more key points within a predefined range of a current position of the user, and determining one or more further key points associated with the determined key point. The method also includes tracking, by each of the one or more further key points, whether the user stops at a particular key point of the one or more further key points, and setting a mode of transportation of the user to a public transportation mode in response to said tracking indicating that the user stops at the particular key point of the one or more further key points.

### CROSS REFERENCE TO RELATED APPLICATIONS

This application is a continuation of PCT International Application No. PCT/EP2015/066506, filed Jul. 20, 2016, which claims priority under 35 U.S.C. § 119 from German Patent Application No. 10 2015 209 056.6, filed May 18, 2015, the entire disclosures of which are herein expressly incorporated by reference.

### BACKGROUND AND SUMMARY OF THE INVENTION

The present invention relates to the field of detecting modes of transportation of a user. In particular, the present invention relates to the field of detection at least a public transportation mode of a user.

Existing approaches for detecting a mode of transportation may map sensor data of a mobile device to a behavior of a user. For example an accelerometer sensor a Global Positioning System, GPS, sensor may be used to determine whether a user is on foot or on a motorized vehicle. In more general terms, the accelerometer sensor or the GPS sensor of a mobile device may be used to differentiate between a motorized and a non-motorized transportation mode of a user. The research work of Stenneth at al. (Stenneth, L, Wolfson, O., Yu, P. S., Xu, B.: Transportation Mode Detection Using Mobile Phones and GIS Information. In: Proceedings of the 19th ACM SIGSPATIAL International Conference on Advances in Geographic Information Systems, GIS 11, pp 54-63. Nee York, N.Y., USA, ACM, 2011) discloses a mixture of classifiers, e.g. average speed, average acceleration, or average bus location closeness, and several classification models to detect a mode of transportation. However, the research work of Stenneth at al. may require live positioning information of busses or trains to detect the mode of transportation.

Accordingly, there may be a need for methods and systems which efficiently improves a detection of modes of transportation. In particular, there may be a need for a system which efficiently increases a detection rate of modes of transportation even if live positional information of transportation systems, in particular public transportation systems, might not be available.

According to an aspect of the invention, there is provided a computer-implemented method for detecting modes of transportation of a user. The method detects one or more key points in a digital map, determines a key point of the one or more key points within a predefined range of a current position of the user, and determines one or more further key points associated with the determined key point. By each of the one or more further key points, the method tracks whether the user stops at a particular key point of the one or more further key points. If the user stops at the particular key point of the one or more further key points, a mode of transportation of the user is set to a public transportation mode. This may provide the advantage that a user may be efficiently detected in a public transportation system only by tracking key points, e.g. stations of a public transportation system.

According to an embodiment of the invention, the method may set the mode of transportation of the user to a car transportation mode, if the user stops at none of the one or more further key points. This may provide the advantage that the key points may be efficiently used to determine whether the user uses a car, i.e. whether the user is in the car transportation mode.

According to a further embodiment of the invention, the one or more further key points may be determined based on one or more connections of one or more public transportation systems available at the determined key point. This may provide the advantage that associations between key points bet be automatically determined based on connections and/or lines of one or more public transportation systems between key points.

According to a further embodiment of the invention, the method may detect a transition of the mode of transportation of the user when the user is in the public transportation mode. The detecting of the transition of the mode of transportation of the user may comprise: determining an even further key point associated with the particular key point at which the user stops; determining one or more transition key points associated with the particular key point, wherein a transition key point is a key point which is nearby the particular key point and is arrived by walking from the particular key point; setting the mode of transportation of the user to a transition mode; tracking the even further key point and the one or more transition key points to determine whether the user stops at one of these key points; and if the user stops at one of these key points, setting the mode of transportation of the user to the public transportation mode. This may provide the advantage that a transition between public transportation systems may be efficiently detected. In particular, the transition may be detected at latest when stopping at the next key point. Accordingly, any change of lines of the same public transportation system or a change between different transportation systems may be efficiently detected at high accuracy.

According to a further embodiment of the invention, the method may set the mode of transportation to a walking state if the user stops at none of these key points. This may provide the advantage that also non-motorized modes of transportation may be detected correctly. The walking state may be used as fallback if no transition and no further use of public transportation systems may be detected.

According to a further embodiment of the invention, the method may receive a movement activity of the user and a probability of the movement activity from an activity detection engine, wherein the activity movement engine may detect the movement activity at least based on an acceleration sensor. The method may map the movement activity of the user to a motorized state if the movement activity indicates that the user uses a vehicle at a probability above a predefined threshold. Further, the method may set the mode of transportation to a motorized state. This may provide the advantage that additional information from e.g. an activity engine may be easily integrated and used to detect intermediate modes of transportation such as the motorized state. This may increase the correctness for detecting a public transportation system.

According to a further embodiment of the invention, the method may set the mode of transportation of the user to a public transportation mode, if the mode of transportation is in the motorized state and the user stops at the particular key point of the one or more further key points. This may provide the advantage that a result of an activity detection engine, e.g. the detection of the motorized state, may be combined with the detecting of key points, e.g. the particular key at which the user stops, to efficiently increase the accuracy of detecting a public transportation system.

According to a further embodiment of the invention, the tracking whether the user stops at one of the one or more further key point may comprise: setting a key point logic of a key point of the one or more key points to a tracking state; calculating a probability for arriving at a key point of the one or more further key points based on a distance from the user to the key point; and if the calculated probability decreases below a predefined threshold, removing the key point of the one or more further key points. This may provide the advantage that key points which may be arrived only with a low probability may be sorted out fast. The computational efficiency may increase, since less key points may have to be tracked.

According to a further embodiment of the invention, the probability is a weighted probability. By using a weighted probability, key points may sorted out faster so that the number of tracked key points may be reduced faster. Further, key points in an area with a high density of key points may be evaluated more efficiently by using a weighted probability.

According to a further embodiment of the invention, the tracking whether the user stops at one of the one or more further key point may comprise: determining whether the user is within a predefined distance to a particular key point of the one or more further key points; if the user is within a predefined distance to the particular key point of the one or more further key points, setting the key point logic of the particular key point to a check if the user stops state; detecting whether the user stops at the particular key point of the one or more further key points; and if the user stop at the particular key point, setting the key point logic of the particular key point to an on public state; and setting the mode of transportation to the public transportation mode. This may provide the advantage that transitions between public transportation systems may be detected more efficiently.

According to a further aspect of the invention, there is provided a system for detecting modes of transportation of a user, wherein the system is adapted to perform the method as described above.

According to a further aspect of the invention, there is provided a computer program product for detecting modes of transportation of a user, the computer program product, when being executed by a data processor, is adapted for carrying out the method as described above.

As used herein, reference to a computer program or a computer program product is intended to be equivalent to a reference to a program element and/or to a computer readable medium containing instructions for detecting modes of transportation of a user as described above.

The computer program may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The invention may be realized by means of a computer program respectively software. However, the invention may also be realized by means of one or more specific electronic circuits respectively hardware. Furthermore, the invention may also be realized in a hybrid form, i.e. in a combination of software modules and hardware modules.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this document.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an exemplary representation of key points as a key point graph.

FIG. 2 shows an exemplary state diagram of a key point logic.

FIG. 3 shows an exemplary state diagram of a global logic.

FIG. 4 shows an exemplary scenario of a key point.

FIG. 5 shows an overview of transitions of an exemplary key point.

### DETAILED DESCRIPTION OF THE DRAWINGS

The application describes a knowledge-based system which may make logical decision based on key points. The knowledge-based system may logically differentiate between multiple transportation modes. It is assumed that public transportation systems may be bound by rails or might not leave their route when using streets. It is further assumed that the public transportation systems may generally stop at one or more stations and/or may have a particular schedule.

Detecting a user's movement type, e.g. walking, driving in a car or using a public transport system, may be of increasing importance in multiple applications. Providing a specific mode of transportation may enable real-time guidance and/or rerouting information for users of the specific mode of transportation. In particular, user of public transportation systems may receive real-time information of a particular vehicle of a particular public transportation system. For example, the user may receive real-time information whether a user has chosen a bus in the correct direction according to his preferences. Further, real-time guidance may be provided, in case a user has missed, and i.e. has not entered, a particular vehicle of a public transportation system.

In particular, the system may identify a current used public transport system and a direction of the used public transport system, a station at which the user is currently waiting, and at which station the user is leaving. The system makes decisions based on a knowledge-based system. The knowledge-based system may be applied to any particular city or region. The system may determine multiple modes of transportation including “walking”, “car” and/or “public transport”. A focus of the system is a detection of public transportation modes, whereas detailed information about the current used public transport may be delivered by the system. The detailed information may cover a current line, a next station while using public transportation, an entry point and an exit point. The system may detect a public transportation mode with an accuracy of about 95%.

Any location which may help identifying a position of a user may be defined as a key point. In addition, key points may comprise locations which may provide additional contextual and/or logical information to detect a position of a user. A key point may be identified by a location and/or by one or more sensors of a mobile device. A key point may be a location of a station or a stop of a public transportation system. In other words, the key point may provide contextual and/or logical information of a public transportation system. For example, a key may be a bus station, a tram station or a taxi station. Additionally and/or alternatively, access points, e.g. wireless access points, may be put into relation to other key points to improve accuracy of detecting a key point.

In the following, a key point may represent a station of one or more public transportation systems. A key point may be associated with another key point according to a connection or a line of a public transportation system. In particular, the key points and the associations between the key points may define a directional graph, where each node of the graph is a key point and each edge may represent one or more lines or connections of one or more public transportation systems.

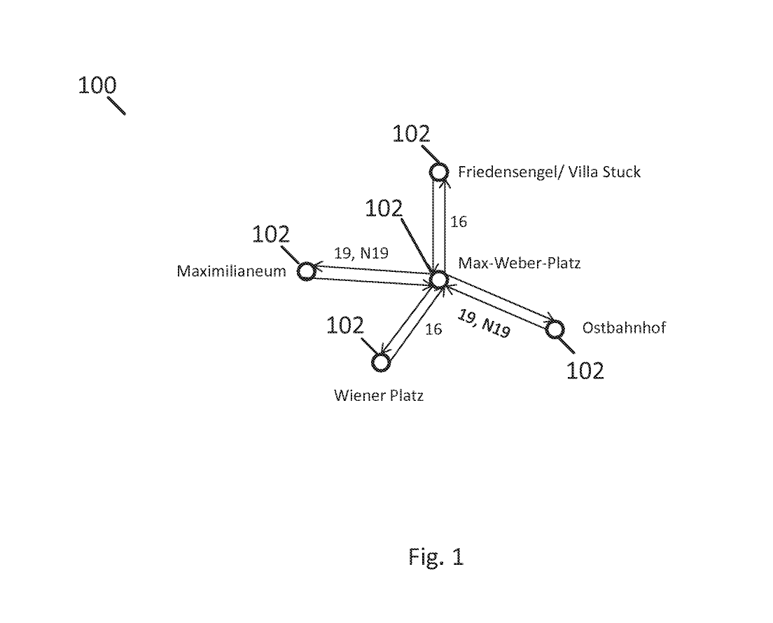

FIG. 1 shows an exemplary representation of key points as a key point graph 100. The key point graph may be a directional graph comprising key points as nodes and connections or lines between key points as edges. One or more lines or connections may be associated with each edge of the key point graph. As illustrated in FIG. 1, an exemplary key point graph may comprise five key points 102. The edges between the key points 102 may illustrate in which direction a transportation system, in particular a public transportation system, may move. The one or more numbers associated with each edge may describe which line of a public transportation system provides a connection between a pair of key points. For example, lines 19 and N19 of a tram may connect the key points “Ostbahnhof” and “Max-Weber-Platz” in both directions.

Further, multiple key points may be grouped as a key point cluster. The key point cluster may be used to identify a single key point representing multiple, identified key points. For example, each entrance to a subway station may be a key point. The key points of all entrances to the subway station may be grouped as a key point cluster. The key point cluster may represent the particular subway station. If a user may be close to an entrance of the subway station, the system may return a high probability for the user entering the particular subway station. By grouping multiple key points as a key point cluster, geographical locations of a station, e.g. an underground station, may be set into relation to the station itself.

The system may calculate a probability for arriving at a particular key point according to a movement of a user. Closer key points, i.e. key points which are close to the user, may have a higher probability than key points which may be further away from the user. In particular, the probability may be calculated using the following equations. Equation (1) may calculate a total distance from a current location of a user to one or more key points:

$$sumDistance = {\sum }_{i = 0}^{n} {d}_{i}$$

where dᵢ is a distance from a current location of a user to a particular key point i, and 72 is a number of key points identified within a predefined distance around a user.

Equation (2) may calculate the inverse of a flat distance distribution between all currently weighted key points:

$$ℐ ( d ) = {( \frac{d}{sumDistance} )}^{- 1} = \frac{sumDistance}{d}$$

The nearest key point, i.e. the key point which has the lowest distance to a current position of a user, may have the largest percentage and the furthest key point, i.e. the key point which has the largest distance to a current position of a user, may have the lowest percentage. If a density of key points is high, the inverse of the flat distance distribution might not determine a probability which allows making a decision based on the probability. For example, the density of key points in a center of a city may be high. Accordingly, the probability for all key points may be low and a decision might not be possible based on the probability.

Therefore, weighting functions may be used to improve the probability and to allow making decision based on the probability. The weighting function of equation (3) may determine a differential weight:

$$+ 1 = \frac{{d}_{t - 1} - {d}_{t}}{{d}_{t - 1}} + 1 , if Δ d > - {d}_{t - 1} 1 , otherwise$$

Key points that may be approached faster may be weighted higher than key points that stay at the same distance. The probability for key points which move away may be significantly reduced. Equation (3) uses only the latest position of the user and the current distance between the key points. If the user moves back and forth, the probability may be incorrectly reduced for key points which may have a longer distance to the current position of the user. Thus, an average of e.g. the last three or five distances may be used to capture any oscillating movements of a user and calculate a more accurate probability.

In addition to the differential weighting function above or as an alternative to the differential weighting function above, Equation (4) may calculate an exponential weighting for a key point.

[symbol]

(d)ε[1,10]; [symbol] (d)=1+9*e^{-d*0.026347}

The exponential weighting may be applied only when the distance of the user to a key point may be below a predefined threshold. For example, the exponential weighting may be applied only to distances below 200 meters from the user to the key point. Any larger distance of the user to the key point may not modify the weighting.

Equation (5) may define the final weight of a key point:

W(d)=( [symbol] (d)* [symbol] (d)* [symbol] (d))

Equation (6) may define the total weight of all key points:

$$𝒮 = {\sum }_{i = 0}^{n} 𝒲 ( {d}_{i} )$$

Equation (7) may define the probability of arriving a particular key point based final weight of equation (5) and the total weight of equation (6):

$$𝒫 ( d ) = 100 * \frac{𝒲 ( d )}{𝒮}$$

Accordingly, the probability may be determined by dividing the final weight and the total weight. Advantageously, the calculations of determining the probability might not require large computational resources so that the calculation may be efficiently performed on a mobile device.

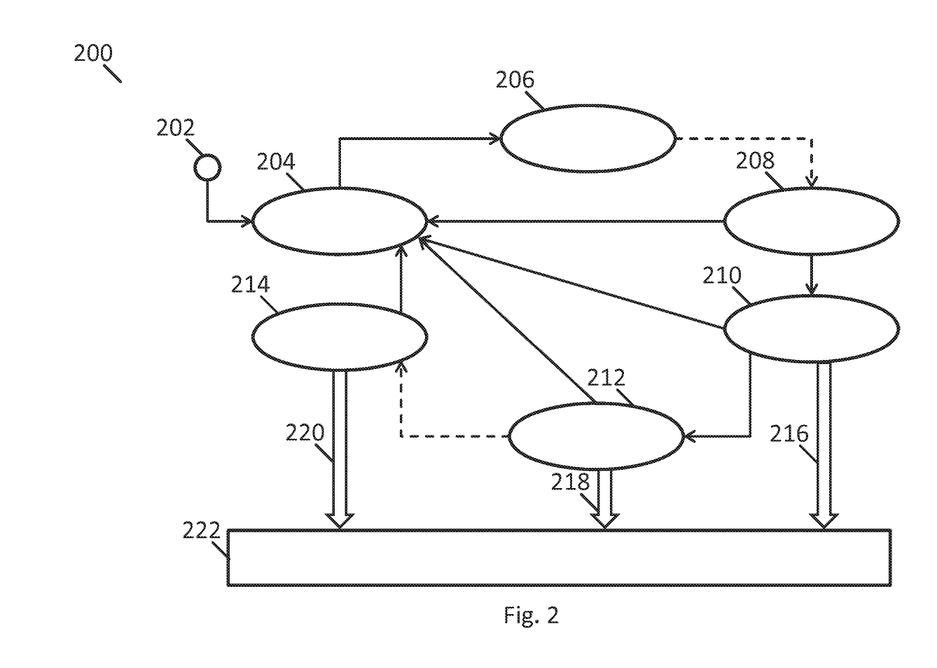

FIG. 2 shows an exemplary state diagram 200 of a key point logic. The key point logic may be performed at each key point. In particular, the system may initialize the key point logic at state 202. At state 204, a list of possible key points may be determined. For determining the possible key point, key points within a predefined range around the current position of a user may be selected in a digital map and added to the list of possible key points. If the system tracks that a user is within a predefined distance to a key point, the key point logic of this key point may switch to the state 206 indicating that the user may be nearby the key point.

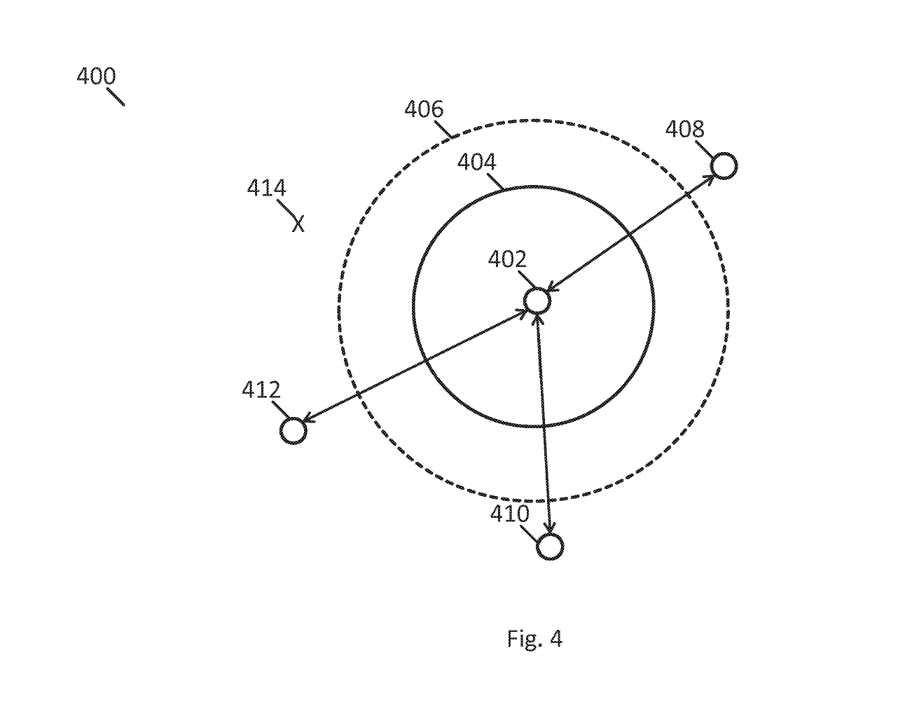

Further details of the key point logic may be described in combination with FIG. 4 below.

When the key point logic of a key point switches from state 204 to state 206, a message may be sent to one or more targeted key points which may be arrived by public transportation systems from the current key point. The one or more targeted key points which receive the message from the current key point may track whether the user arrives at one of these targeted key points in the tracking state 208 of the key point logic 200. After sending the message to the targeted key points, the system may reset the key point logic of the current key point to the initial state 202. If the user moves closer to one of the targeted key points, the key point logic of this key point may switch from the tracking state 208 to the check if stops state 210. More specifically, if the distance from the current position of the user to the position of one of the targeted key points falls below a predefined threshold, the key point logic of this key point may switch from the tracking state 208 to the check if stops state 210. For example, the predefined threshold may be about 200 meter. Preferably, the predefined threshold may be four times the size of the predefined threshold used for detecting whether a user is nearby a key point in state 206 of the key point logic. Increasing the predefined threshold may provide the advantage to improve the accuracy when determining or checking whether the user stops at one of the targeted key points.

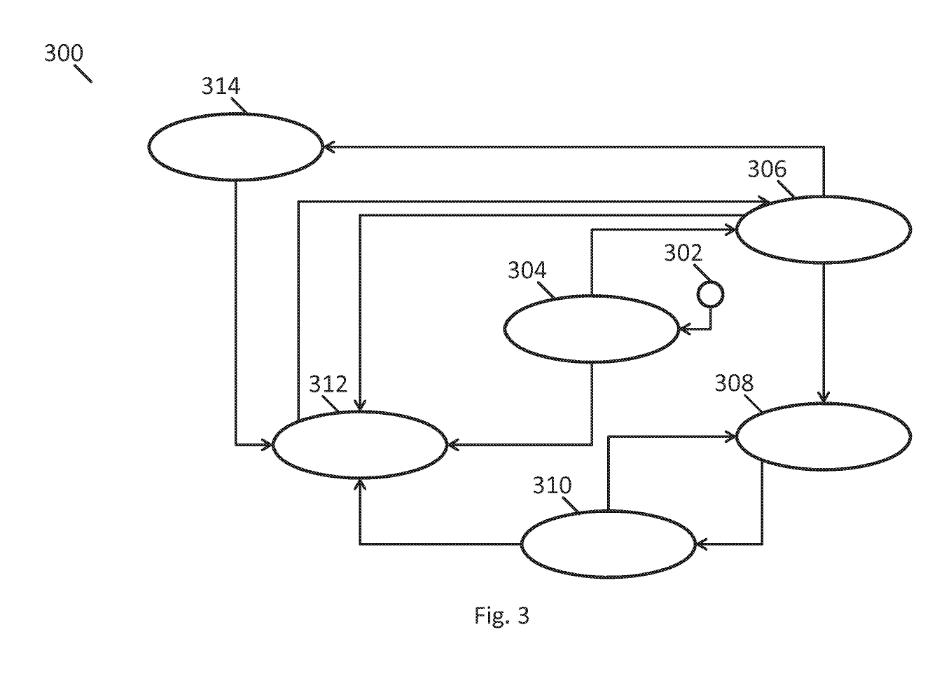

If the user stops at one of the targeted key points, a message 216 indicating that the user is in a public transportation system may be sent to a global logic of the system. The global logic is described with respect to FIG. 3 below. The key point logic of the targeted may point may switch to the on public state 212. In the on public state 212, the key point logic may determine targeted key points again and may send a message to these key points so that the targeted key points may check if the user stops at one of the targeted key points. The targeted key points may switch to the check if stops state 214. Further, the check if stops state may increment a counter determining the number of stops of the user. The on public state 212 of the key point logic may further send a message 218 to the global logic of the system indicating that the user may perform a transition, e.g. the user may leave the public transportation system and/or the user may change public transportation systems or lines of a particular public transportation system.

Based on the key point logic of a key point, a process of making decisions based on one or more detected key points is described in the following. The logic for making decisions may comprise a key point logic for each of the key points as described above in FIG. 2 and a global logic as illustrated in FIG. 3 below. The key point logic may be performed at each key point. In other words, each key point may comprise a state machine for making decisions.

The global logic may gather messages, e.g. notifications and/or events, from the key point logic of each key point. Further, the global logic may make decisions of a mode of transportation of a particular user.

FIG. 3 shows an exemplary state diagram 300 of a global logic. In particular, the global logic may comprise six states. Primary states, i.e. states which specify a mode of transportation, may comprise a walking state 312, a car state 314, and a public transportation state 308. Helper states, i.e. states which may help to correctly determine a primary state, may comprise an unknown state 304, a transition state 310, and a motorized state 306. After initializing the global logic in state 302, the global logic may be in the unknown state 304.

Starting from the unknown state 304, the global logic may switch to the motorized state 306 and/or to the walking state. The unknown state 304 might not be further specified. A user might be in any primary or helper state when the global logic is in the unknown state. In particular, a primary state of the global logic might not have been detected in the unknown state 304. The global logic may determine whether a user is walking or using a motorized vehicle. If a user does not move, the global logic may wait for a movement of a user.

For example, an activity recognition engine may be used to determine whether a user is in a walking state 312 or a motorized state 306 of the global logic. An implementation of an activity recognition engine may use an accelerometer sensor of a mobile phone to differentiate between a walking state 312 and a motorized state 306. For example, an activity recognition application programmer interface API of the Android operation system OS may be used to determine whether a user is in the walking state 312 or the motorized state 306 of the global logic. When using the activity recognition API of the Android OS, the states walking, running, and/or on foot may be mapped to the walking state 312 of the global logic. Further, the car state of the activity recognition API of the Android OS may be mapped to the motorized state 306 of the global logic, since the activity detection API of the Android OS might not be able to differentiate between multiple motorized vehicles like busses or trains.

While in the unknown state 304 or the walking state 312 of the global logic, the system may search for key points. The search for key points may be limited to a search area. A range of the search area may be dependent on the location of a user. For example, the search range in the center of a city may be a few hundred meter, e.g. about 200 meter. For example, the search range in a country region may be a few kilometers. A result of the search for key points may be incorporated into a key point list. Each key point of the key point list may be a candidate for a user entering or leaving a transportation system, and in particular, a public transportation system. The system may remove a key point of the key point list as soon as the key point leaves the search area. Additionally or alternatively, the system may remove a key point from the key point list if the key point is not viable for a public transportation system.

If the global logic is in the motorized state 306, the system may detect two modes of transportation, a public transportation mode or a car transportation mode. The global logic may switch from the motorized state 306 to the car state 314 or the public transportation state 308. A transition from the motorized state 306 to the public transportation state may be described with FIG. 4.

FIG. 4 shows an exemplary scenario 400 of an exemplary key point 402. As mentioned above, each key point may have a key point logic as described above in FIG. 2. Thus, each key point may modify the states of the key point logic independently from another key point. As presented in FIG. 4, a user 414 may approach at the key point 402. In particular, the user 414 may approach at the key point 402 by entering an area limited by the circle line 404. If the user is located in the area between the key point 402 and the circle line 404, i.e. the user is nearby the key point 404, the key point logic of the key point 402 may send a message to the global logic. The message may notify the global logic about the user being nearby the key point 402.

If the user is located in the area between the key point 402 and the circle line 404, the user may use a public transportation system associated with the key point 402 or the user may pass by the key point 402 without using the transportation system associated with the key point 402. In any case, the system may track whether the user leaves the area between the key point 402 and the circle line 404, and/or an area between the circle line 404 and a circle line 406. For example, a range of the circle line 404 may be about 50 m and a range of the circle line 406 may be 75 meter.

When the user leaves the key point 402 and passes the circle line 406, the system may identify all possible key points by following the directional edges of the key point graph 100. In other words, all edges are tracked for targeted key points. For example, the user may use the key point 402 to move to the key points 408, 410, and 412 as targeted key points. The key point logic of the key point 402 may send a message to each key point logic of the key points 408, 410, 412. When receiving the message from the key point 402, the key points may track whether the user is approaching one of the key points 408, 410, 412. If the probability of at least one of the key points 408, 410, 412 decreases, this or these key points may be sorted out. When a key point is sorted out, the key point logic of this key point may be reset to an initial state.

If the user approaches at one of the key points 408, 410, 412, the system may determine whether a speed of movement of the user may drop below a given threshold. For example, the system may determine whether the speed of movement of the user drops below 5 kilometers per hour. If the speed of the user drops below the given threshold, all lines associated with an edge of the key point graph to the targeted key point may be candidates of public transportation systems which a user may be using. Since multiple lines may be associated with one edge of the key point graph, all lines may have the same likelihood. When live departure times may be available at the targeted key point, a particular line of a public transportation system may be selected based on a comparison of the arrival or departure time of the public transportation system and the arrival or departure time of the user of the targeted key point. If no live arrival or departure times are available at the targeted key point, lines of the public transportation systems may be dismissed when a line splits up at a particular key point, i.e. a line is not available any more for arriving at a next targeted key point.

If the key point logic of the targeted key point detects that the user is approaching or stopping the targeted key point by e.g. decreasing the speed of movement, the key point logic may send a message to the global logic indicating that the user is stopping at the targeted key point. The global logic may receive the message and may switch from the motorized state to the public transportation state. In other words, the global logic may set the mode of transportation to the public transportation mode. When changing the mode of transportation to the public transportation mode or public transportation state, a public transportation system may be detected by the system.

Next, when a public transportation is detected, i.e. the global logic is in the public transportation state, a user may change the transportation system. For example, the user may change the underground line at a station or the user may change a train at a station. In order to detect a transition between one or more lines of a transportation system or a transition between different transportation systems at a particular key point, the transition state 310 of the global logic 300 may be used. When a user arrives at the targeted key point, the key point logic may forward a message to the next key point. Hereby, the system may prioritize lines between the current key point and the one or more targeted key points. If additional lines may stop at the current station and/or there are transitions between lines available, transitions and/or other lines may be also tracked because the user might exit or change at the current key point.

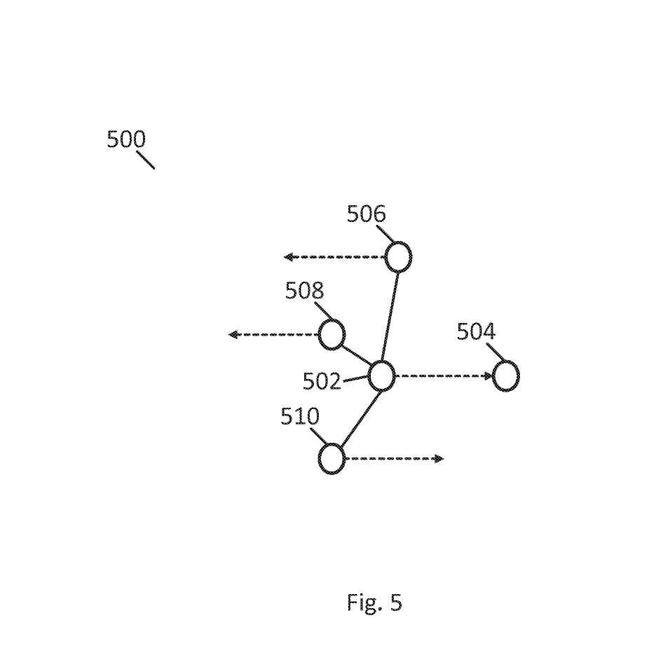

FIG. 5 illustrates an overview 500 possible transitions at an exemplary key point 502. The key point 502 may be the key point at which a user is currently located. The key point logic of the key point 502 may send a message to a key point logic of a next key point 504. The next key point 504 may be a key point in a direction of a line of a public transportation system associated with a directional edge of a key point graph. In other word, the key point 502 may be incremented by the system to the key point 504.

As illustrated in FIG. 4, the key point 502 may comprise three key points 506, 508, and 510 as transition points. Edges between the key point 502 and the key points 506, 508, and 510 of FIG. 4 may indicate that a transition between these key points may be possible. These edges may checked when the system detects that the next point 504 has not been arrived by the user. For example, the system may determine whether the user has arrived the next key point 504 within a predefined time limit. Additionally or alternatively, the system may detect that the probability of arriving the next key point 504 decreases below a predefined threshold. If the system detects the user has not arrived at the next key point 504 within a predefined time limit and/or the probability of arriving the next key point 504 is below the predefined threshold, the system may track whether the user may be arriving at one of the transition points. Again, the system may determine, for each transition point, the probability that the user arrives a respective key point. A transition point with a probability below the predefined threshold may be dismissed as a transition point.

The global logic 300 may comprise fallback conditions to prevent the global logic from staying in an incorrect state. The fall back condition may be used to switch from the transition state 310 to the walking state 312 of the global logic. Fallback conditions may be reset each time when the global logic may switch to the transition state 310. Resetting the fallback condition may enable the global logic to restart the determining of a mode of transportation for the user from the unknown state 304 or the walking state 312 of the global logic 300.

The fallback conditions may comprise a timeout. The timeout may be determined by a distance from a key point and/or a current position of a user to a next key point. For determining the timeout, the system may estimate a maximum time frame in which the next key point may be arrived. The timeout may be triggered when a user may departure from a key point. The timeout may be applied to the global logic only if any other fallback conditions might not be applicable. As a further fallback condition, the system may use a decrease of the probability of arriving at a targeted key point. The probability of arriving at a targeted key point may decrease significantly when a user may move to a different direction. If the probability is decreasing below a predefined threshold, the global logic may trigger the fallback condition. If a user switches between different modes of transportation at a particular key point, the fallback condition based on the probability might not be triggered because distances at a particular key point may be too short.

A further fallback condition may be based on an activity recognition engine. If the activity recognition engine detects the walking state 312 of the global logic 300 with a very high likelihood, i.e. the activity recognition engine may detect that a user may be walking, running, or moving on foot with a very high likelihood, the global logic may switch from the transition state 310 to the walking state 312 of the global logic as a fall back condition. An activity may be detected by the activity recognition engine only in the transition state 310, since the activity recognition engine may provide incorrect results when a user is using a public transportation mode. In other words, the fallback conditions may ensure that the global logic may timely and/or accurately detect the walking state when being in the transition state 310 of the global logic.

The global logic may also detect whether a user is using a car. If the global logic detects that the user is using a car, the global logic may switch from the motorized state 306 to the car state 314. In order to determine whether a user is using a car, key points may be used. As described above, the global logic may switch to the motorized state 306 from the unknown state 304 or the walking state 312, when the activity recognition engine may detect a motorized state with a probability above average, e.g. above 60%. When the global logic 300 is in the motorized state 306, the system may determine one or more key points in a predetermined range around the current position of a user. If the key point logic of each of these key points determines that the user might not be on a public transportation system, the global logic may switch from the motorized state 306 to the car state 314. In other words, the user is using a car whenever no key point logic may indicate that the user is using a public transportation system.

The system has been tested using the activity recognition engine of the Android 4.2 OS platform. For a test with 3000 key points, 4000 edges and around 260 public transportation lines. The correct mode of transportation may be detected with an accuracy of about 95 to 97%. Advantageously, the system may provide an accurate prediction of the transportation system which a user is currently using.

Advantageously, the detecting of a public transportation mode may be performed in realtime. No historical data of a user may be required. Further, addition key points, e.g. key points based on points of interest, may be added to the system so that the accuracy of detecting a particular key point may be increased.

It should be noted that the term “comprising” does not exclude other elements or steps and the use of articles “a” or “an” does not exclude a plurality. Also elements described in association with different embodiments may be combined. It should also be noted that reference signs in the claims should not be construed as limiting the scope of the claims.

### LIST OF REFERENCE SIGNS

100 key point graph
102 key point
200 state diagram of a key point logic
202 initial state
204 possible point state
206 near point state
208 tracking state
210 check if stops state
212 on public state
214 check if stops and increment state
216 message
218 message
220 message
222 global logic
300 state diagram of a global logic
302 initial state
304 unknown state
306 motorized state
308 public transportation state
310 transition state
312 walking state
314 car state
400 scenario of a key point
402 key point
404 circle line
406 circle line
408 key point
410 key point
412 key point
414 current position of user
500 overview of transitions of a key point
502 current key point
504 targeted key point
506 transition key point

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A computer-implemented method for detecting modes of transportation of a user, wherein the method comprises the acts of:
detecting one or more key points in a digital map;
determining a key point of the one or more key points within a predefined range of a current position of the user;
determining one or more further key points associated with the determined key point;
tracking, by each of the one or more further key points, whether the user stops at a particular key point of the one or more further key points; and
setting a mode of transportation of the user to a public transportation mode in response to said tracking indicating that the user stops at the particular key point of the one or more further key points.

2. The method according to claim 1, further comprising:
setting the mode of transportation of the user to a car transportation mode in response to said tracking indicating that the user stops at none of the one or more further key points.

3. The method according to claim 1, wherein the one or more further key points are determined based on one or more connections of one or more public transportation systems available at the determined key point.

4. The method according to claim 2, wherein the one or more further key points are determined based on one or more connections of one or more public transportation systems available at the determined key point.

5. The method according to claim 1, further comprising:
detecting a transition of the mode of transportation of the user when the user is in the public transportation mode,
wherein detecting the transition of the mode of transportation of the user comprises:
determining an even further key point associated with the particular key point at which the user stops;
determining one or more transition key points associated with the particular key point, wherein a transition key point is a key point which is nearby the particular key point and is arrived at by walking from the particular key point;
setting the mode of transportation of the user to a transition mode;
tracking the even further key point and the one or more transition key points to determine whether the user stops at one of these key points; and
setting the mode of transportation of the user to the public transportation mode if the user stops at one of these key points.

6. The method according to claim 2, further comprising:
detecting a transition of the mode of transportation of the user when the user is in the public transportation mode,
wherein detecting the transition of the mode of transportation of the user comprises:
determining an even further key point associated with the particular key point at which the user stops;
determining one or more transition key points associated with the particular key point, wherein a transition key point is a key point which is nearby the particular key point and is arrived at by walking from the particular key point;
setting the mode of transportation of the user to a transition mode;
tracking the even further key point and the one or more transition key points to determine whether the user stops at one of these key points; and
setting the mode of transportation of the user to the public transportation mode if the user stops at one of these key points.

7. The method according to claim 3, further comprising:
detecting a transition of the mode of transportation of the user when the user is in the public transportation mode,
wherein detecting the transition of the mode of transportation of the user comprises:
determining an even further key point associated with the particular key point at which the user stops;
determining one or more transition key points associated with the particular key point, wherein a transition key point is a key point which is nearby the particular key point and is arrived at by walking from the particular key point;
setting the mode of transportation of the user to a transition mode;
tracking the even further key point and the one or more transition key points to determine whether the user stops at one of these key points; and
setting the mode of transportation of the user to the public transportation mode if the user stops at one of these key points.

8. The method according to claim 5, the method further comprising setting the mode of transportation to a walking state if the user stops at none of said key points.

9. The method according to claim 1, further comprising:
receiving a movement activity of the user and a probability of the movement activity from an activity detection engine, wherein the activity movement engine detects the movement activity at least based on an acceleration sensor; and
mapping the movement activity of the user to a motorized state if the movement activity indicates that the user uses a vehicle at a probability above a predefined threshold; setting the mode of transportation to a motorized state.

10. The method according to claim 9, further comprising setting the mode of transportation of the user to a public transportation mode if the mode of transportation is in the motorized state and the user stops at the particular key point of the one or more further key points.

11. The method according to claim 1, wherein said tracking whether the user stops at one of the one or more further key point comprises:
setting a key point logic of a key point of the one or more key points to a tracking state;
calculating a probability for arriving at a key point of the one or more further key points based on a distance from the user to the key point; and
removing the key point of the one or more further key points if the calculated probability decreases below a predefined threshold.

12. The method according to claim 11, wherein the probability is a weighted probability.

13. The method according to claim 1, wherein said tracking whether the user stops at one of the one or more further key point comprises:
determining whether the user is within a predefined distance to a particular key point of the one or more further key points,
wherein if the user is within a predefined distance to the particular key point of the one or more further key points, the method further comprises
setting the key point logic of the particular key point to a check if the user stops state;
detecting whether the user stops at the particular key point of the one or more further key points,
wherein if the user stop at the particular key point, the method further comprises
setting the key point logic of the particular key point to an on public state;
setting the mode of transportation to the public transportation mode.

14. A system configured to detect modes of transportation of a user, wherein the system is configured to:
detect one or more key points in a digital map;
determine a key point of the one or more key points within a predefined range of a current position of the user;
determine one or more further key points associated with the determined key point;
track, by each of the one or more further key points, whether the user stops at a particular key point of the one or more further key points; and
set a mode of transportation of the user to a public transportation mode in response to said tracking indicating that the user stops at the particular key point of the one or more further key points.

15. A computer program product for detecting modes of transportation of a user, the computer program product comprising a non-transitory readable medium containing instructions which, when executed by a processor, cause the processor to:
detect one or more key points in a digital map;
determine a key point of the one or more key points within a predefined range of a current position of the user;
determine one or more further key points associated with the determined key point;
track, by each of the one or more further key points, whether the user stops at a particular key point of the one or more further key points; and
set a mode of transportation of the user to a public transportation mode in response to said tracking indicating that the user stops at the particular key point of the one or more further key points.
